(19) United States
(12) Patent Application Publication
(10) Pub. No.: US 2005/0204593 A1
(43) Pub. Date: Sep. 22, 2005

(54) Production method for a number for a motor vehicle, number plate for a motor vehicle and device for carrying out said method

(76) Inventors: Wolfgang Bilger, Siegen (DE); Lothar Wurmbach, Siegen (DE)

Correspondence Address: CANTOR COLBURN, LLP, 55 GRIFFIN ROAD SOUTH, BLOOMFIELD, CT, 06002, US

(21) Appl. No.: 10/513,842

(22) PCT Filed: May 5, 2003
(86) PCT No.: PCT/DE03/01633

§ 371 Date: May 13, 2005

(30) Foreign Application Priority Data
May 8, 2002 (DE) 102 20 756.9
Jun. 14, 2002 (DE) 102 26 718.9

(51) Int. Cl. G09F 7/00; G09F 19/00

(52) U.S. Cl. 40/200; 40/615

(57) ABSTRACT

The invention relates to a production method for a number plate for a motor vehicle, comprising the following steps: 1. Imprinting a carrier film (2) with individual signs (7) in a printing step, 2. Laminating the printed carrier film (2) on a stampable carrier plate (1) in a laminating step, and 3. Mechanical stamping of the carrier plate (1) laminated with printed carrier film (2) according to the contour (8) of the individual signs (7), which are produced in the printing step, in a stamping step.

The subject matter of the present invention is a method of manufacturing motor vehicle license plates, a device suitable for carrying said method into effect as well as a motor vehicle license plate manufactured using said method.

To the present day, two basic types of motor vehicle license plates are known worldwide. The first type of motor vehicle license plates (referred to herein after as type I) comprises a lettering consisting of mechanically embossed distinguishing characters. After embossing, which is generally performed so as to produce raised characters, these distinguishing characters are dyed. This type is a standard type in many parts of the world such as for example in Germany and in most of the US states.

The second type (referred to herein after as type II) consists of a flat license plate the lettering of which is imprinted on a carrier film using conventional or digital printing methods, said carrier film being generally bonded to a carrier plate after printing.

The type I motor vehicle license plates thereby comprise an additional “macro safety characteristic” since embossing of the registration number involves further expense and since the lack of such a embossed lettering is very easy to recognize when the license plate is being visually controlled.

As compared thereto, the type II license plates, which are produced using a printing method, have the advantage that they offer more freedom when designing them so that, on the one hand, customized license plates may be produced according to the ideas of the owner of the motor vehicle and so that, on the other hand, additional safety characteristics may be applied thereto in accordance with the pertinent national regulations.

In spite of the obvious advantages of the two types of license plates and of the methods used for manufacturing them, it has not yet been possible to produce motor vehicle license plates capable of combining the advantages of both types of license plates. The main reason therefore is that the methods used for manufacturing the embossed motor vehicle license plates do not allow for individually printing each license plate separately.

It is therefore the object of the present invention to indicate a method of manufacturing motor vehicle license plates that permits to manufacture license plates using a printing method while still making it possible to preserve the additional safety characteristic realized by the embossed lettering. It is another object thereof to indicate a device suitable for carrying said method into effect as well as a license plate that can be manufactured using said method.

The solution to these objects is achieved by a manufacturing method in accordance with claim 1, by a motor vehicle license plate in accordance with the claims 11 and 12 as well as by a device for producing motor vehicle license plates in accordance with claim 17.

The manufacturing method in accordance with claim 1 comprises the following method steps:
1. in a printing process, producing the lettering of the registration number by imprinting distinguishing characters onto a carrier film,
2. in a laminating process, laminating the printed carrier film onto a embossable carrier plate, and
3. in a embossing process, mechanically embossing the carrier plate lined with the printed carrier film according to the contours of the distinguishing characters produced in the printing procedure.

In principle, the exact order of the method steps 1 and 2 is not important; what is important to the present invention is that the printing process be carried into effect in a method step preceding the embossing process and that embossing be carried out so as to conform to the contour of the printed lettering of the registration number.

The term “distinguishing characters” is to be construed as the lettering of the registration number, meaning the registration number as it is prescribed by national regulations, consisting for example of letters and numbers. These may for example perform the function of being indicative of the place of registration of the motor vehicle.

The manufacturing method of the invention differs from the prior art method of manufacturing type I motor vehicle license plates as described herein above by the order of the method steps, the method of the invention thus realizing major advantages over the prior art method. More specifically, the method of the invention makes it possible to produce, by interchanging well known method steps, motor vehicle license plates having new micro safety characteristics that could not be realized hereto before so that motor vehicle license plates may be manufactured that are much more difficult to falsify than the prior art motor vehicle license plates.

As explained in the preamble, in the prior art method of manufacturing type I motor vehicle license plates, the carrier plate of the license plate is first provided with a embossing the raised surfaces of which are dyed in the next method step. The disadvantage of this method is that it is only possible to emboss distinguishing characters comprising, within their outline contours, a substantially plane surface that is oriented to be parallel to the plane of the carrier plate. Otherwise oriented plane surfaces or even curved surfaces of the embossed distinguishing characters cannot be produced in this way since dyeing of the distinguishing characters produced by embossing using prior art dyeing methods is not possible because of the orientation and/or shape of the surfaces.

This is most obvious from the method, still currently used in the USA, according to which a liquid ink is applied to the raised surfaces of the embossed distinguishing characters using an ink roller. In order to make certain that the ink is uniformly applied; it is indispensable that the surfaces of the embossed distinguishing characters be plane and disposed in one common plane.

However, embossed distinguishing characters having substantially plane surfaces disposed in one common plane are also the prerequisite of the method presently used in Germany for example, which consists in dyeing the raised regions of the embossed distinguishing characters by ink transfer from a transfer film.

By dyeing the distinguishing characters in a printing process in a first method step, by laminating next the distinguishing characters imprinted on a carrier film onto the carrier plate and by embossing, conforming to their contour, these distinguishing characters produced in the printing process by using a suited device in the last final step only, it is made possible for the first time to design the embossed distinguishing characters in different colors.

More specifically, it is possible to hereby dye differently oriented surface regions of the distinguishing characters in different colors. Characters may thus be produced that are embossed in just the same manner as the embossed distinguishing characters of today's German license plates. As before, said characters can have their plane surfaces, which are oriented to be parallel to the carrier plate, dyed with one color, but now, their flank, which is inclined to the plane of the carrier plate, is additionally dyed with another color. Having the flanks of the embossed distinguishing characters dyed with another color constitutes a possibility to provide an additional new micro safety characteristic that can be checked directly and most simply by mere visual control by the police for example.

The embossed distinguishing characters may further comprise a embossed substructure that is disposed within the contour of the distinguishing characters. It would not be possible to dye such a embossed substructure using the prior art dyeing methods or such a embossed substructure would not allow dyeing of the embossed distinguishing characters within their outline contour altogether. Using the method of the invention however, it is also possible to dye embossed distinguishing characters having a embossed substructure within their contour with one color or even with multiple colors within their contour. Such a embossed substructure, if it is disposed within the contour of the embossed distinguishing characters, also constitutes an additional new micro safety characteristic that makes falsification of motor vehicle license plates manufactured using the method of the invention much more difficult.

In combining the new micro safety characteristics of embossed license plates discussed herein above e.g., in both providing the embossed distinguishing characters produced by the method of the invention with a substructure within their contour and dyeing them with multiple colors in the manner described above, falsification is made particularly difficult. The following is one possible combination of the new micro safety characteristics:
dyeing the embossed distinguishing characters with multiple colors within the raised regions thereof formed by embossing and
embossed and/or different colored substructure within the embossed distinguishing characters.

In a preferred developed implementation of the manufacturing method of the invention, the distinguishing characters are printed on the front face of the carrier film in the printing process. Next, the back face of the printed carrier film is laminated to the carrier plate. In this implementation of the method of the invention, a transparent protective film may be additionally laminated to the front face of the printed carrier film prior to embossing the laminated carrier plate. The dye of the distinguishing characters may thus be durably protected from the weather and from mechanical abrasion. In contrast to the license plates manufactured using today's current printing methods, the presently utilized current type I motor vehicle license plates, which have their lettering dyed in a hot embossing process, generally do not require a protective film.

The front face of the printed carrier film may also be sealed with a transparent protective varnish rather than provided with a protective film, said varnish protecting the distinguishing characters produced in the printing process against mechanical abrasion, weather and UV aging. Such a e.g., UV curing protective varnish may be applied allover the finished printed and embossed motor vehicle license plate by dip coating for example.

A film configured in one or in multiple colors can be used to advantage as the carrier film. It may more specifically comprise additional micro safety characteristics as they are known from prior art. Such known micro safety characteristics are e.g., laser markings (“laser engraving”) that are visible only at certain viewing angles.

The optionally applied transparent protective film may also comprise additional micro safety characteristics of the type mentioned.

In an alternative implementation of the manufacturing method of the invention, the distinguishing characters are printed mirror inverted onto the back face of the carrier film in the printing process, with the carrier film being transparent or at least translucent. In the subsequent laminating process, the back face of the carrier film is laminated to the carrier plate so that the distinguishing characters produced in the printing process are sandwiched between the carrier plate and the transparent carrier film, being thus also reliably protected from the weather and from mechanical abrasion.

In this alternative implementation of the manufacturing method of the invention, further advantages are achieved by laminating a base film to the front face of the carrier plate in an additional method step that is to be performed prior to laminating. In the laminating process, the printed carrier film is then laminated to said carrier plate, which is lined with the base film. A retro reflective film, which may more specifically also be dyed with one or with multiple colors, may for example be used as the base film. Said base film may further comprise additional micro safety characteristics as they are known in the art, such as markings that are visible only at certain viewing angles for example and the like. The transparent carrier film too can comprise additional micro safety characteristics of the type mentioned herein above.

In a first alternative, the motor vehicle license plate of the invention is based on a embossable carrier plate, on a base film laminated to the front face of the carrier plate and on distinguishing characters that are produced using a printing method, the motor vehicle license plate comprising at least one of the following micro safety features:
a region dyed in a printing process, said region being associated with a certain embossed distinguishing character of the lettering of the license plate and being disposed within said character, with the dyed region being non-parallel oriented with regard to the plane of the carrier plate,
a embossed substructure that is disposed within the contour of a embossed distinguishing character of the lettering of the license plate.

Examples of such a dyed region include the embossed face of a distinguishing character of a conventionally embossed type I motor vehicle license plate that is configured in a color different from the one in which are configured the top surfaces of the distinguishing character that are oriented substantially plane-parallel with regard to the plane of the carrier plate.

The term “embossed substructure” is to be construed as a structure produced by embossing that modifies the conventional embossed cross section of a distinguishing character in such a manner that the embossed distinguishing character can no longer be uniformly dyed within the resulting colored contour of the character using a subsequent printing method as used for dyeing the lettering of the registration number of conventional type I motor vehicle license plates. Examples thereof include relief structures that are additionally embossed onto the embossed cross section, symbols such as letters that are embossed with a recessed shape, or the very embossed cross section, the latter comprising several facets such as steps or large impressions. Further details will be discussed in connection with the exemplary embodiments.

In its first alternative, the motor vehicle license plate can be directly manufactured using the method of the invention. It improves the conventional type I license plates by providing additional micro safety characteristics that make falsification of the license plate much more difficult. Additional regions that are designed in another color and are provided within the distinguishing characters of the lettering of the license plate additionally contribute to making the distinguishing characters more visible.

In a second alternative, the license plate of the invention is based on a embossable carrier plate, on a protective film laminated to the front face of said carrier plate and on distinguishing characters disposed between carrier plate and protective film and produced using a printing method. The composite system consisting of carrier plate, protective film and distinguishing characters is mechanically embossed according to the contour of the distinguishing characters so as to provide distinguishing characters that are raised within their contour. Such a motor vehicle license plate may be advantageously manufactured using the method in accordance with the invention, the advantages that may be realized using this method having already been put forward. Particularly suited implementations of the method are recited in the subordinate claims 3 and 5. Environmental stability of the printed license plate lettering is further enhanced by providing a protective film which hereto before could not be readily applied to the surface of a embossed license plate having a dyed lettering.

The motor vehicle license plate of the invention in accordance with the second alternative may further comprise one or several of the micro safety characteristics that have been described herein above and that can be realized using the manufacturing method of the invention.

The license plate of the invention may for example comprise another safety characteristic in the form of a embossed substructure disposed within the contour of the distinguishing characters and produced in the embossing process. Said substructure may be implemented in the same color as the remainder of the surface of the distinguishing character of concern but may also comprise a plurality of other colors.

Another possible additional micro safety characteristic is that the raised regions of the distinguishing characters formed in the embossing process are configured in multiple colors. The flanks of the distinguishing characters in particular may for example be another color than the raised regions of the distinguishing characters which, after embossing, are oriented to be parallel to the surface of the carrier plate. Particularly the motor vehicle license plates that are presently common in Germany can be advantageously improved in this manner.

As a matter of course, any combination of the micro safety characteristics that can be produced using the manufacturing method of the invention is possible and advantageous.

The motor vehicle license plate of the invention comprises particular advantages if a carrier film is disposed between the carrier plate and the distinguishing characters, said carrier film being laminated to the front face of the carrier plate. This carrier film may for example be a retro reflective film as it is known from prior art, or a single- or multi-colored film that may also comprise additional micro safety characteristics.

In a particularly advantageous developed implementation of the manufacturing method of the invention, a embossing unit is provided for carrying the embossing process into effect. A printing unit is further provided for performing the printing process. To carry out the manufacturing method of the invention, the printing unit transmits information regarding the position and/or the type of the distinguishing characters to be embossed to the embossing unit. As used herein, “position” means the precise arrangement on the carrier plate of the distinguishing characters to be embossed. “Type” refers to the information as to which character—meaning which letter, number or other character—is to be embossed and in which font or other shape the character is to be embossed.

Depending on the design of the device for carrying the manufacturing method of the invention into effect, it may be advantageous to perform automated optical recognition of the position and/or type of the distinguishing characters to be embossed as an alternative, or a complement, to the information transfer from the printing unit to the embossing unit described herein above and to use the thus obtained information for embossing. Particular advantages are hereby obtained if the manufacturing method is performed fully automatically.

The device of the invention for producing the motor vehicle license plates of the invention using the manufacturing method of the invention includes the following features:
1. a printing unit for performing the printing process
2. a embossing unit for performing the embossing process using embossing tools,
3. said embossing unit comprising an automatic positioning device for automatically positioning embossing tools above the distinguishing characters to be embossed.

By providing an automatic positioning device as being part of the embossing unit, it is possible to have the method steps “printing process” and “embossing process” carried out automatically in sequence without intervention by a user. The essential prerequisites for efficiently carrying out the method of the invention on a large technical scale are thus provided.

A laminating unit may additionally be provided to advantage so that the entire method in accordance with the invention can be carried out with said device.

In a first particularly preferred device of the invention, there is further provided an optical recognition device for recognizing the position and/or type of the distinguishing characters to be embossed and for transmitting this information to the embossing unit. Such an optical recognition device can for example rely on capturing images of the surface of the composite system to be embossed and on the subsequent processing of said images, image processing being set to recognize the precise position of the distinguishing characters on the carrier plate and the precise type thereof. As a result, such an optical recognition device can advantageously rely for operation on a suited camera e.g., a CCD camera topped by an image processing system, more particularly by a computer based image processing system.

In an alternative developed implementation of the device of the invention, the printing unit is designed to transmit to the embossing unit information regarding the position and/or type of the characters to be embossed. As a rule, a digitally actuated printing unit will be used to produce the distinguishing characters in the printing process so that precise information regarding the position and/or type of the printed distinguishing characters is available in the printing unit or in the associated electronic drive and can be readily transmitted to the embossing unit.

In another preferred developed implementation of the device of the invention, the embossing unit further comprises an automatic tool selection device for selecting a suited embossing tool for performing the embossing process on a distinguishing character to be embossed. The embossing tool will be chosen so as to be adapted to the type of the character to be embossed.

Finally, in a particularly preferred developed implementation of the device of the invention, the embossing unit is further designed to receive external information regarding the position and/or type of the characters to be embossed from an external source, for example from the printing unit or the optical recognition device, and to use this information for automatically selecting and/or positioning embossing tools for carrying out the embossing process. Meaning, the information received from an external source is used for actuating the automatic selection device and/or the automatic positioning device, each of them having been designed to process this information and to take it as a basis for the method steps they perform.

In an alternative implementation, the device of the invention for carrying the method of the invention into effect includes the following features:
1. a printing unit for carrying out the printing process,
2. a embossing unit for carrying out the embossing process and
3. a central control unit for actuating the printing unit and the embossing unit.

Prior art devices are known that consist of a more or less loose assembly of a embossing unit and of a kind of printing unit, viz. a device for applying ink onto the raised regions of embossed distinguishing characters. With such a loose assembly of individual units, it is only possible to carry out the method of the invention at the expense of an increase in complexity, though.

By providing a central control unit, which actuates at least the printing unit and the embossing unit, it is possible to automatically coordinate the printing process and the subsequent embossing process, this coordination being necessary for implementing the method of the invention.

In this case too, a laminating unit, which can also be actuated by the central control unit, may be optionally integrated in the device in order to synchronize the method steps performed by the laminating unit with the method steps carried out by the printing unit and/or the embossing unit.

Further advantages and features of the device of the invention will become apparent upon reading the subordinate claims and the following description of embodiments thereof, given by way of example only with reference to the drawing in which:

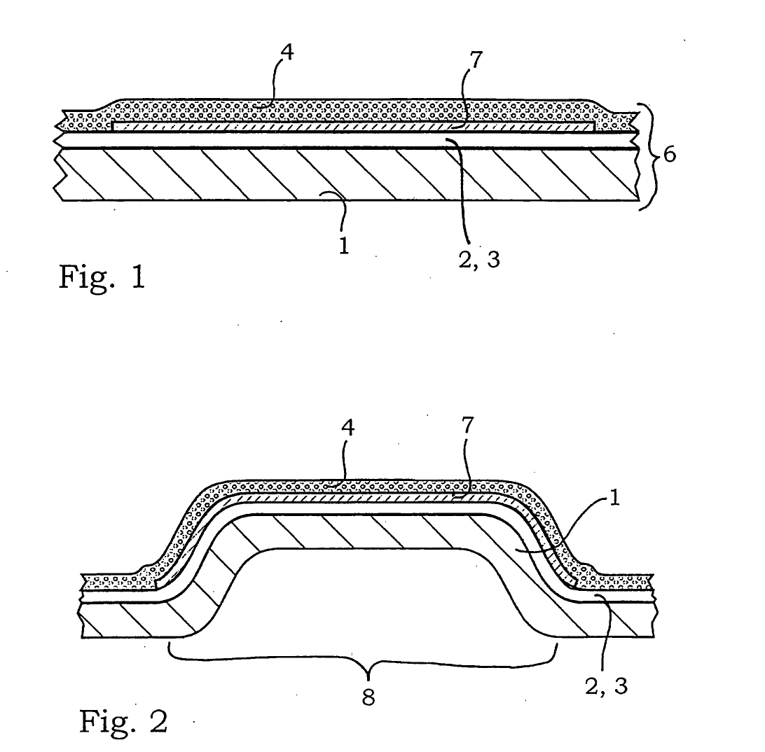

FIG. 1 is a sectional view of the composite system of a license plate prior to embossing,

FIG. 2 is a sectional view of the composite system of a license plate after embossing,

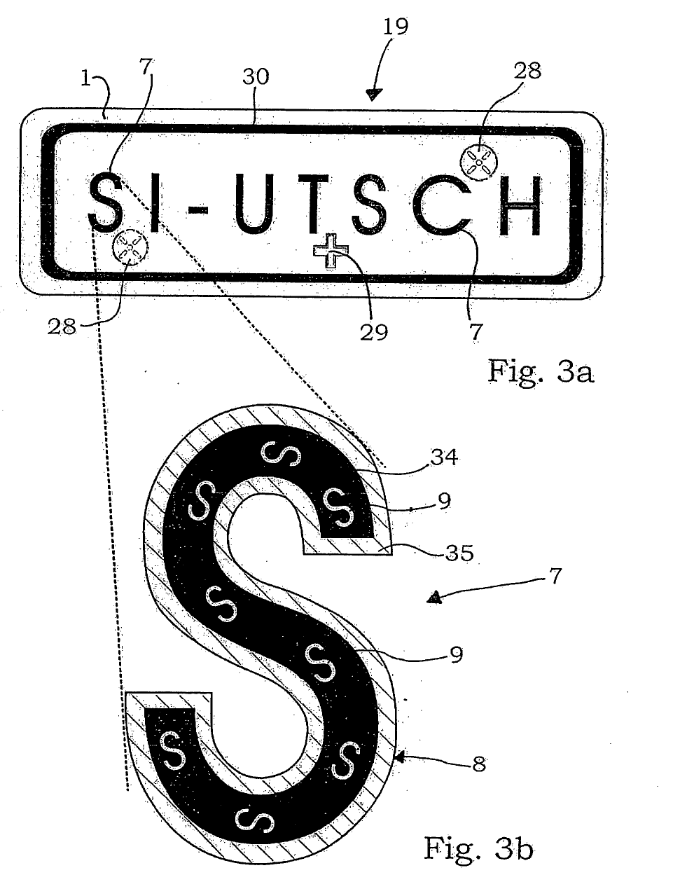

FIG. 3a is a top view of a license plate of the invention,

FIG. 3b shows the contour of a printed but not yet embossed distinguishing character,

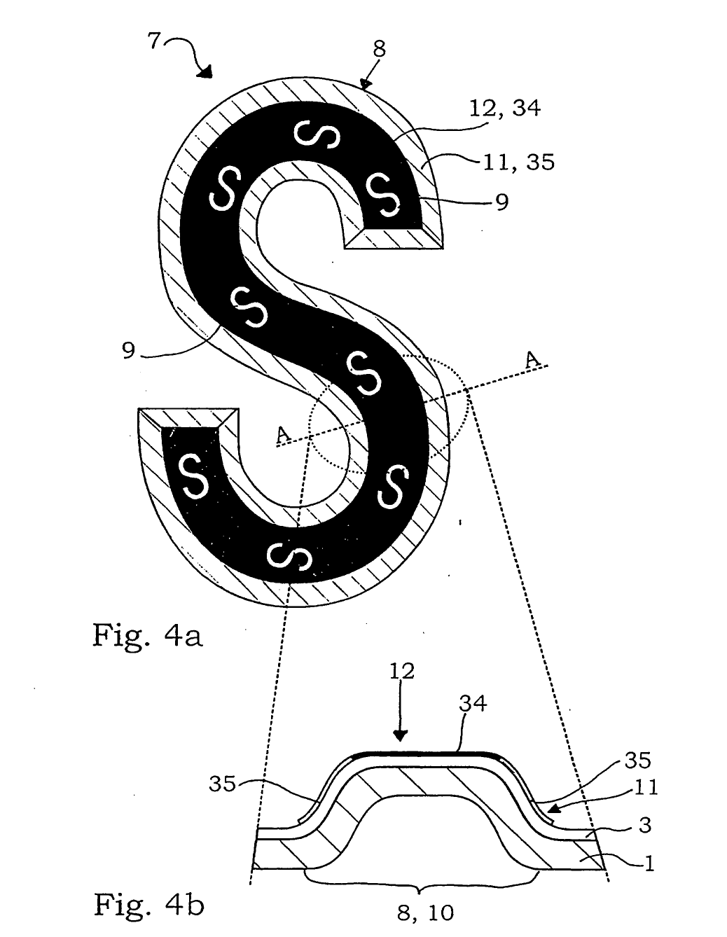

FIG. 4a shows the distinguishing character of FIG. 3b after embossing with a first type of substructure within the contour,

FIG. 4b is a sectional view taken along the line A-A of the embossed character of FIG. 4a,

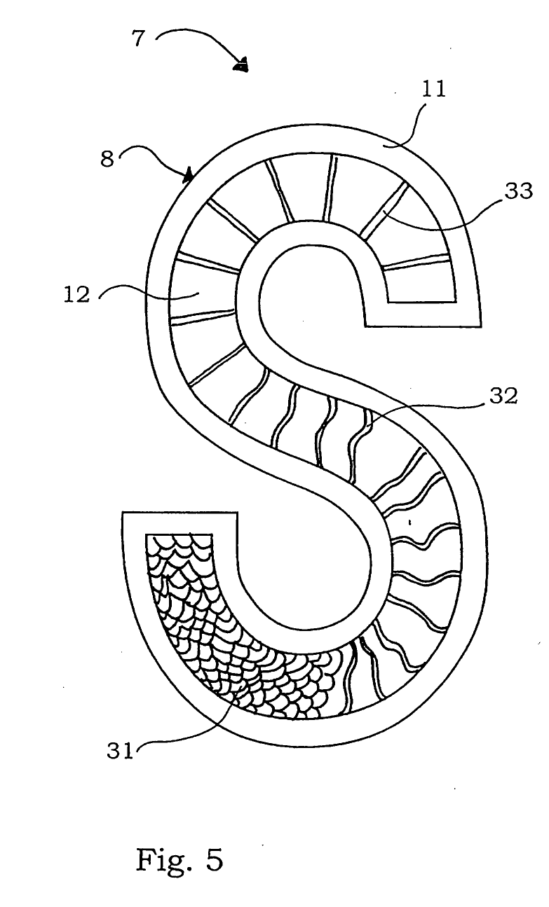

FIG. 5 shows a distinguishing character after the embossing process has been performed with further substructures within the contour,

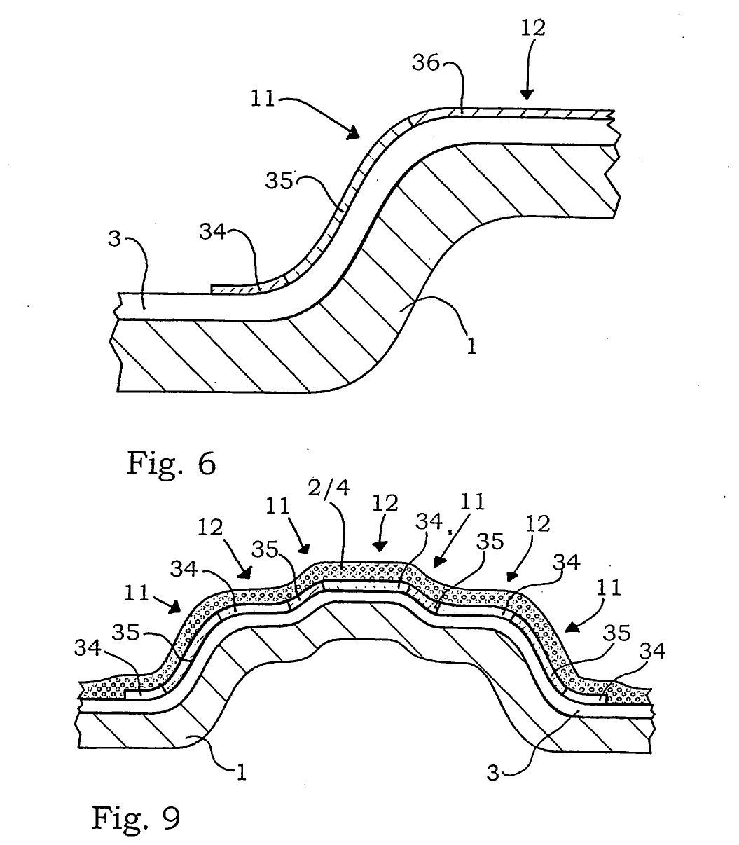

FIG. 6 is a sectional view of a flank of a embossed distinguishing character configured in multiple colors,

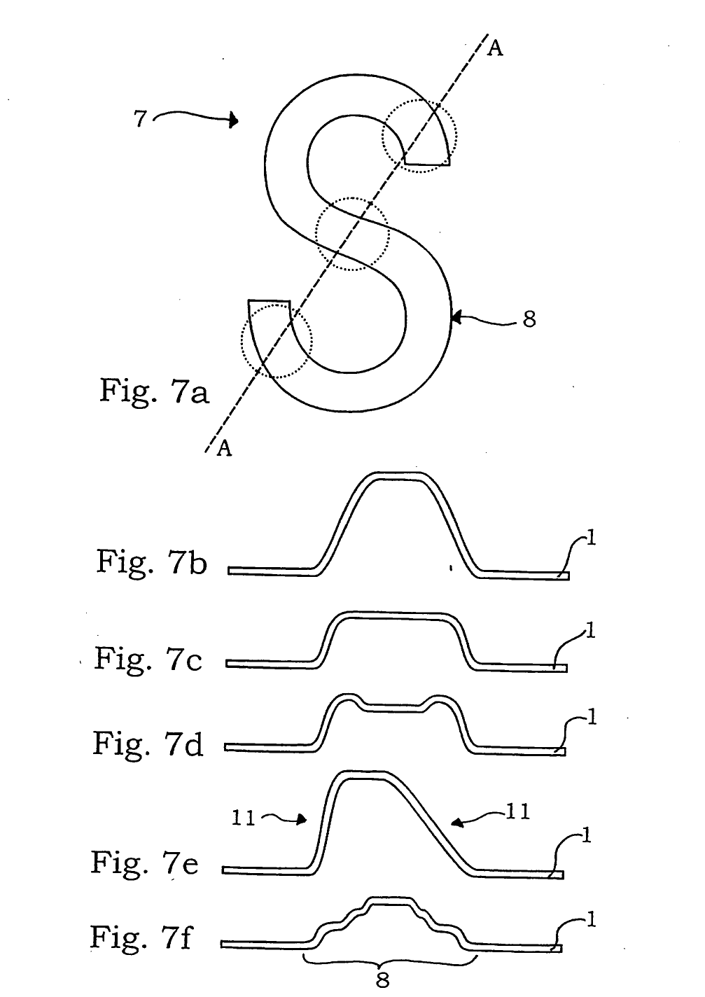

FIG. 7a is a top view of the contour of a distinguishing character,

FIGS. 7b to f: are various sectional views of the carrier plate of a license plate in the region of a embossed distinguishing character taken along the line A-A of FIG. 7a, and

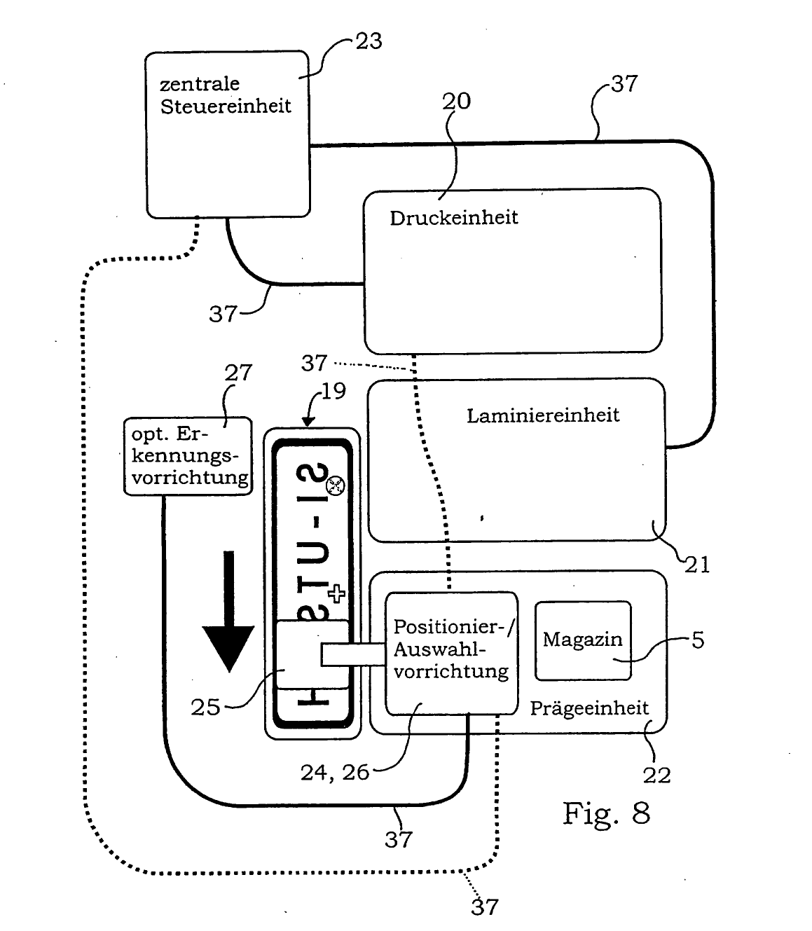

FIG. 8 is a schematic illustration of a device of the invention for centralized production of motor vehicle license plates,

FIG. 9 is a sectional view of a distinguishing character with a plurality of micro safety characteristics,

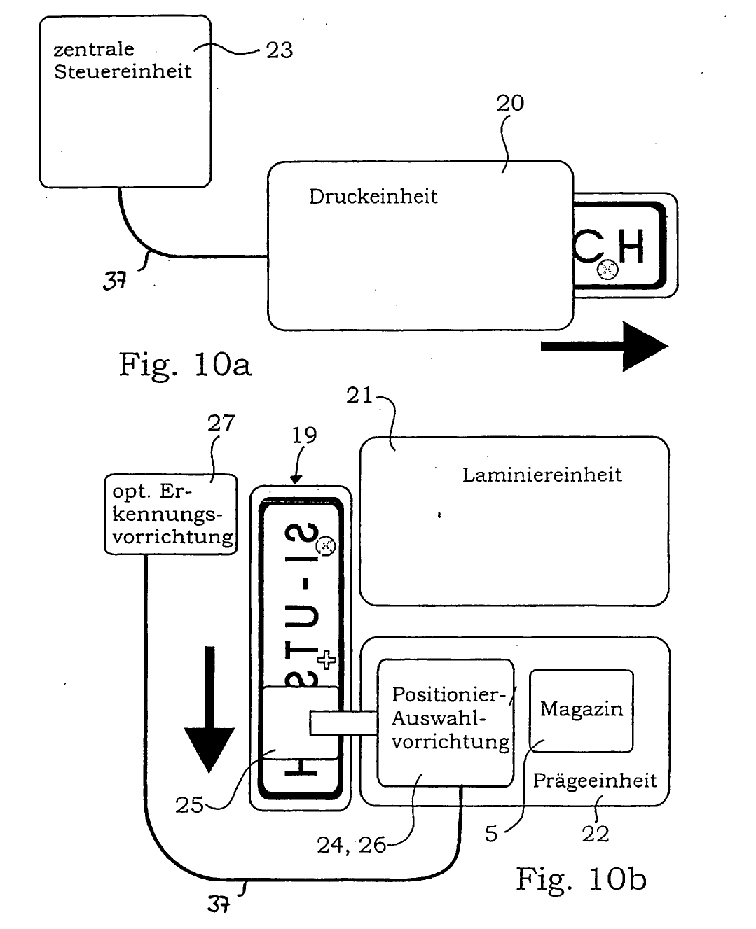

FIG. 10a is a schematic illustration of a printing unit for centralized printing and

FIG. 10b is a schematic illustration of a laminating and embossing unit for decentralized completion of a motor vehicle license plate.

Manufacturing a license plate using the method of the invention can proceed as follows:

The carrier plate 1 is sheared out of an aluminum strip. Using a printing unit 20, the lettering of the motor vehicle license plate that is to be produced, which consists of distinguishing characters 7, as well as at need further design and/or safety elements dictated either individually or by the authorities, are imprinted onto a carrier film 2. Next, the custom cut printed portion of the carrier film 2 is laminated to the carrier plate 1 using a laminating unit 21. Then, a protective film 4 is laminated to the carrier plate 1, which is lined with the printed carrier film 2, using the laminating unit 21. Next, the composite system 6, which consists of the carrier plate 1, of the carrier film 2 bearing the distinguishing characters 7 printed thereon and of the protective film 4, is fed to a embossing unit 22. From the printing unit 20, said embossing unit 22 has received information regarding the position and the type of the distinguishing characters 7 to be embossed. Using an automatic selection device 26, the embossing unit 22 selects the embossing tools 25 suited for embossing the printed distinguishing characters according to the contour 8 and positions them fittingly above the contour 8 of the distinguishing characters 7 to be embossed using an automatic positioning device 24. As an alternative to the automatic positioning of the embossing tool 25, it is also possible to automatically position the carrier plate 1 of the motor vehicle license plate to be embossed. A device suited for centralized implementation of the method described is shown in FIG. 8.

In an alternative manufacturing method, the lettering of several motor vehicle license plates to be produced, which consists of at least the distinguishing characters 7, is printed sequentially or parallelly onto a portion of the carrier film 2 of sufficient length, using a digital printer. Said portion is laminated to a strip portion of appropriate dimensions and made of a suited carrier material, more specifically of a metal such as aluminum or steel sheet or of a embossable plastic material such as ABS or PVC. This composite system, which is in the form of a strip portion, is fed to the embossing unit 22 that sequentially or parallelly embosss the distinguishing characters 7 of the motor vehicle license plates to be produced along their contour. In this case again, the embossing unit 22 selects the embossing tools 25 suited for embossing according to the contour 8 of the distinguishing characters using an automatic selection device 26 and positions said tools fittingly above the contour 8 of the distinguishing characters 7 to be embossed using an automatic positioning device 24. As an alternative to the automatic positioning of the embossing tool 25, it is also possible to automatically position the carrier plate 1 of the motor vehicle license plate to be embossed. In the final manufacturing step, the various motor vehicle license plates 19 are sheared out of the strip portion.

In an alternative embodiment, the embossing unit 22 comprises an optical recognition device 27 consisting of a CCD camera for registering the surface of the motor vehicle license plate to be embossed and of an electronic image processing system mounted downstream thereof. Said optical recognition device 27 is designed to recognize the position and type of the distinguishing characters 7 to be embossed on the supplied motor vehicle license plate 19 and to transmit them to the automatic positioning device 24 and to the automatic selection device 26.

The composite system supplied to the embossing unit 22 can be seen from FIG. 1 which illustrates a sectional view thereof (the section line passing for example through the carrier plate 1 of the motor vehicle license plate shown in FIG. 8 in the region of a letter). It consists of a carrier plate 1 to the front face of which there is laminated a carrier film 2 or a base film 3 consisting of a retro reflective film. A protective film 4, which is transparent, is laminated to the front face of the base film 3, the distinguishing characters 7, i.e., the lettering of the motor vehicle license plate to be produced, having been printed mirror inverted onto said protective film in a previous method step. Suited printing methods include for example a digital thermal transfer printing method. The protective film 4, the bottom face of which bears the printed distinguishing characters 7, is next laminated to the top surface of the base film 3 lining the carrier plate 1 so that the distinguishing characters 7 are correctly oriented and visible through the transparent protective film 4 when the carrier plate 1 is viewed from the top.

The protective film 4 may also be configured to be translucent, the only important point being that the distinguishing characters disposed between the protective film 4 and the base film 3 are visible through the protective film 4.

As an alternative to the approach discussed herein above, the embossed composite system 6 that can be seen from FIG. 1 can also be made by printing the lettering of the license plate onto a carrier film 2. The front face of the (not embossed) carrier plate 1 is then lined with said printed carrier film 2. Next, the front face of the printed carrier film 2 is lined with a transparent or at least translucent protective film 4 providing protection against mechanical abrasion, the weather and UV-radiation, with the distinguishing characters 7 of the motor vehicle license plate 19 being sandwiched between the carrier film 2 and the protective film 4.

FIG. 2 shows the sectional view according to FIG. 1 of the motor vehicle license plate manufactured using the method of the invention after the embossing process has been performed. The structure of the composite system 6 corresponds to the one shown in FIG. 1. From FIG. 2 it can be additionally seen that the mechanical embossing of the sectioned distinguishing character 7 has only been performed within the contour 8 of the character 7.

FIG. 3a shows the non-embossed composite system of a license plate 19 as viewed from the top. The lettering of the license plate consisting of distinguishing characters 7 can be clearly seen. Additionally, first laser markings 28 are embossed into the base film 3 in the form of micro safety characteristics. A second laser marking 29 in the form of a micro safety characteristic is also made in the protective film 4.

For increased clarity, FIG. 3b depicts the first distinguishing character 7, an “S” in the present case, to an enlarged scale. Said character 7 is printed in two colors within its contour 8. In the region of the future top surface 12, the character is printed in a first color (in black for example) so that a first colored region 34 is formed. Within said first colored region 34, there is disposed a plurality of substructures 9 that are printed another color (yellow for example) and that represent, in the example as shown, the character 7 itself, i.e., an “S”.

The region of the character that constitutes the flank 11 of the character after the embossing process has been performed is implemented in a second color (red for example), a second colored region 35 of the embossed character being thus formed.

For reasons of clarity, it cannot be seen from FIG. 3a that the characters 7 of the motor vehicle license plate shown in FIG. 3a are multicolored and the printed substructures 9 are not illustrated either. However, these features are to be provided on all the characters of the motor vehicle license plate 19.

In FIG. 4a, the character 7 of FIG. 3b is shown once more from the top after the embossing process has been performed. The printed substructures 9 are embossed in a recessed shape according to their colored contour in top surface 12.

Alternatively, these substructures may also be the color of the face in which they are embossed. Using the presently current methods for manufacturing type I motor vehicle license plates, such type substructures of the same color would have to be embossed to the embossed plate already bearing the dyed lettering, which causes considerable engineering problems. Accordingly, embossed substructures configured in the same color also constitute a novel micro safety characteristic that can be realized to advantage using the method of the invention.

FIG. 4b shows a sectional view of the carrier plate 1 of the motor vehicle license plate in the region of said first character 7 that is graphically denoted by the ellipse in FIG. 4a. From this sectional view it can be seen that the embossing is thereby made within the contour 8 of the printed character 7 so as to only form raised regions 10 within said contour 8. Said raised regions comprise top surfaces 12 that are oriented to be substantially parallel to the plane of the carrier plate 1 and so as to conform to the first colored region 34.

In the embossing process, flanks 11 have been further formed, said flanks being substantially inclined to the plane of the carrier plate 1 and oriented so as to conform to the second colored region 35.

Depending on the type and quality of the printing method used for producing the lettering of the license plate, the printed base film 3 may still be lined on its front face with a protective film 4. It is not provided in the exemplary embodiment shown, though.

By selecting the shaping to be achieved with regard to the embossed contour using the embossing tool 25 so that it is adapted to the color chosen for printing the distinguishing character, in the instant case to the first and second colored regions 34 and 35 as well as to the printed substructures 9, a plurality of new additional micro safety characteristics can be realized, which makes it possible to achieve an improvement of the known prior art type I motor vehicle license plates that is very advantageous from a safety perspective.

FIG. 5 shows a distinguishing character 7 of a motor vehicle license plate of the invention after the embossing process has been performed, said character having homogeneously dyed reliefed substructures 9 within its contour 8, said substructures being implemented in the region of the future top surface 12 of character 7 only, the future flanks 11 by contrast showing no such substructures 9. A fish scale type relief pattern 31, a wave type relief pattern 32 and a facet type relief pattern 33 are shown by way of example and can be produced readily using suited embossing tools 25.

FIG. 6 is a sectional view of the carrier plate 1 of a license plate of the invention in the region of the flank 11 of a embossed distinguishing character 7 configured in multiple colors. A first colored region 34 is formed at the base of flank 11, i.e., the embossing of the character 7 follows the contour 8 of the printed character without coinciding therewith though. The embossing reproduces the contour 8 of character 7 at a smaller scale instead. This type of embossing is also intended to be included in the wording of claim 1 “according to the contour 8 . . . (of the character)”. The normal case however is when all the colored regions of the printed character 7 are mechanically embossed along their outermost outline, meaning along the contour of the printed character 7. A second region 35 of another color is formed on the flank 11 and a third region 36 of yet another color is formed on the top surface 12. As used herein, the term “color” refers both to the color temperature and to the color intensity and its reflection factor as well as to the other surface properties of the surface of the colored regions, provided these properties can be influenced using suited printing methods and/or printing inks.

FIG. 7a is a top view of the contour 8 of a distinguishing character 7, the line A-A for the FIGS. 7b to 7f denoting the section line through the embossed carrier plate 1. From the FIGS. 7b to 7f there can be seen different sections through the carrier plate 1 of a license plate in the regions of the embossed distinguishing character 7 denoted by the circles in FIG. 7a, with but the respective raised shape of the character 7 of the carrier plate 1 as produced in the embossing process being shown. It is obvious therefrom that a great freedom in designing the shapes to be embossed is provided, said freedom being restricted only by the embossing process itself. More specifically, the raised shape to be obtained by embossing within the contour of a character 7 can vary; the raised shape of FIG. 7c may for example merge into the raised shape of FIG. 7d. This represents another possibility of realizing an additional micro safety characteristic which substantially can only be realized in conjunction with the inking of the lettering of the license plate using the method of the invention.

FIG. 9 is a sectional view of a embossed distinguishing character 7 that realizes a plurality of micro safety characteristics. The raised shape of the character 7 for example clearly differs from the raised shape of embossed characters 7 on conventional type I license plates. The character 7 thus forms a plurality of top surfaces 12 that are oriented to be parallel to the plane of the carrier plate and are separated from each other by sloping flanks 11. The top surfaces 12 are not arranged in one common plane so that they cannot be dyed homogeneously, in black for example, using the methods for dyeing the lettering of the license plates utilized in the manufacturing of conventional type I license plates. The various top surfaces 12 however form first colored regions 34 that are still dyed with one color—e.g., black. The flanks 11, by contrast, are uniformly dyed with a second color—e.g., red—and form second colored regions 35. The central projection on the center line of the character 7 shown constitutes a embossed substructure 9 that is disposed within the contour 8 of the printed character 7.

FIG. 8 shows a schematic representation of a device in accordance with the invention that realizes the features of the claims 17 to 22 and that is particularly suited for the centralized large scale production of motor vehicle license plates using the method of the invention.

The device consists of a printing unit 20, a laminating unit 21 and a embossing unit 22. The printing unit 20 and the laminating unit 21 are connected via control lines 37 to a central control unit 23 that synchronizes the method steps of the two units 20, 21 together.

After the laminating unit 21 has produced the composite system 6 consisting of the cut out carrier plate 1 and of the carrier film 2 or base film 3 respectively bearing the printed lettering of the license plate and being laminated to said carrier plate, the non-embossed license plate blank is supplied to the embossing unit 22. Then, the embossing unit 22 sequentially embosses the discrete distinguishing characters 7 of the lettering of the license plate. The embossing unit 22 comprises an automatic selection device 26 for respectively selecting the adequate embossing tool 25, the type of the registration number to be embossed being recognized by the optical recognition device 27, which is also provided, and transmitted to the selection device 26. The optical recognition device 27 then synchronizes the embossing unit 22 with the printing unit 20 and/or with the laminating unit 21.

Alternatively, the central control unit 23 or the printing unit 20 may also establish a communication between the automatic selection device 26 and the automatic positioning device for direct data transfer (type and/or position of the distinguishing character 7 to be embossed). Optional control lines 37 provided for this purpose are shown in a dashed line in FIG. 8. In this case, the central control unit 23 synchronizes the operation of the printing unit 20, the laminating unit 21 and the embossing unit 22.

Particular advantages are achieved if the central control unit 23 communicates with a central registering authority for vehicle licensing as this permits to reliably prevent the allocation of twice the same registration number for example.

Then, by means of an automatic positioning device 24, the embossing tool 25, which is selected from a tool magazine 5, is positioned above the position of the character 7 to be embossed recognized by the optical recognition device 27 and mechanical embossing of this character is performed.

The FIGS. 10a and 10b show the two stages of an alternative device for carrying out the method of the invention. Its two-part structure makes it particularly suited for coupled centralized/decentralized production of motor vehicle license plates. Its first stage, which can be seen from FIG. 10a, comprises a central control unit 23 that actuates a printing unit 20. The first stage serves for the preferably centralized production of carrier films 2 or base films 3 bearing the lettering of motor vehicle license plates printed thereon, said films, once produced, being transferred to decentralized embossing stations that produce ready-to-use motor vehicle license plates from the printed carrier films 2 or base films 3 using the second stage of the device. For this purpose, the printed films are laminated onto suited carrier plates 1 using a laminating unit 21. Like before, the lined carrier plates 1 are then mechanically embossed according to the contour of the lettering of the license plate using an automatic embossing unit 22 the structure of which corresponds to the previous exemplary embodiment.

Another possible set of claims for the invention could have the following wording:
1) A method of manufacturing a motor vehicle license plate comprising the following method steps:
   1. producing a composite system consisting of a embossable carrier plate, a protective film laminated to the front face of the carrier plate and distinguishing characters that are disposed between carrier plate and protective film and are produced in a printing process and
   2. mechanically embossing the composite system according to the contour of the distinguishing character in a embossing process.
2) The method of manufacturing a motor vehicle license plate according to claim 1, characterized in that a retro reflective film is disposed between the carrier plate and the distinguishing characters, said film being laminated to the front face of the carrier plate and the protective film being laminated to the front face of the retro reflective film.
3) The method of manufacturing a motor vehicle license plate according to claim 1, characterized in that the distinguishing characters are printed mirror inverted to the back face of the protective film prior to producing the composite system.
4) The method of manufacturing a motor vehicle license plate according to claim 1, characterized in that the distinguishing characters are printed to the front face of the retro reflective film prior to producing the composite system.
5) The method of manufacturing a motor vehicle license plate according to claim 1, characterized in that the distinguishing characters are printed using a digital printing method, more specifically a thermal transfer method.
6) The method of manufacturing a motor vehicle license plate according to claim 1, characterized in that the distinguishing characters are printed using a multiple-color printing method.
7) The method of manufacturing a motor vehicle license plate according to claim 1, characterized in that the printing process and the embossing process are controlled by means of a central control unit.
8) The method of manufacturing a motor vehicle license plate according to claim 1, characterized in that, in the embossing process, embossing tools of the embossing unit are positioned above the distinguishing characters by means of an optical recognition device.
9) A motor vehicle license plate consisting of a embossable carrier plate, a protective film laminated to the front face of the carrier plate and distinguishing characters that are disposed between the carrier plate and the protective film and are produced using a printing method, characterized in that the composite system is mechanically embossed according to the contour of the distinguishing characters.
10) The motor vehicle license plate according to claim 9, characterized in that a retro reflective film is disposed between the carrier plate and the distinguishing characters, said retro reflective film being laminated to the front face of the carrier plate and that the protective film is laminated to the front face of said retro reflective film.
11) The motor vehicle license plate according to claim 9, characterized in that the flanks of the distinguishing characters resulting from the embossing process are configured in another color than the regions of the distinguishing characters that are oriented to be parallel to the surface of the carrier plate after the embossing process has been performed.
12) A device for producing motor vehicle license plates according to claim 9, said device comprising the following features:
   a printing unit for producing the distinguishing characters,
   a laminating unit for producing the composite system,
   a embossing unit for embossing the composite system according to the contour of the distinguishing characters and
   a central control unit that actuates at least the printing unit and the embossing unit.
13) The device according to claim 12, characterized in that there is provided an optical recognition device that is designed to position the embossing tools of the embossing unit above the distinguishing characters.

1) A method of manufacturing a motor vehicle license plate, said method involving the following method steps:
1. in a printing process, imprinting distinguishing characters (7) onto a carrier film (2)
2. in a laminating process, laminating the printed carrier film (2) onto a embossable carrier plate (1) and
3. in a embossing process, mechanically embossing the carrier plate (1) lined with the printed carrier film (2) according to the contour (8) of the distinguishing characters (7) produced in the printing process.

2) The method of manufacturing a motor vehicle license plate according to claim 1, characterized in that in the printing process the front face of the carrier film (2) is printed with the distinguishing characters (7) and that in the laminating process the back face of the carrier film (2) is laminated to the carrier plate (1).

3) The method of manufacturing a motor vehicle license plate according to claim 2, characterized in that, in a further method step performed prior to the embossing process, a transparent protective film (4) is laminated to the front face of the carrier film (2) that has been printed with the distinguishing characters (7) in the printing process.

4) The method of manufacturing a motor vehicle license plate according to claim 1, characterized in that, in another method step, a transparent protective varnish is applied by dip coating to at least the front face of the carrier film (2) that has been printed with the distinguishing characters (7) in the printing process.

5) The method of manufacturing a motor vehicle license plate according to claim 1, characterized in that, in the printing process, the back face of the carrier film (2) is printed with the distinguishing characters (7), said carrier film (2) being transparent, and that in the laminating process the back face of the carrier film (2) is laminated to the carrier plate (1).

6) The method of manufacturing a motor vehicle license plate according to claim 5, characterized in that, prior to the laminating process, a base film (3) is laminated to the front face of the carrier plate (1) in a further method step.

7) The method of manufacturing a motor vehicle license plate according to claim 1, characterized in that there is provided a embossing unit (22) for carrying out the embossing process and a printing process (20) for carrying out the printing process, the printing unit (20) transferring to the embossing unit (22) information regarding the position and/or type of the distinguishing characters (7) to be embossed for carrying the embossing process into effect.

8) The method of manufacturing a motor vehicle license plate according to claim 1, characterized in that automatic optical recognition of the position and/or type of the distinguishing characters (7) to be embossed is performed to carry the embossing process into effect.

9) The method of manufacturing a motor vehicle license plate according to claim 1, characterized in that the distinguishing characters (7) produced in the printing process are configured in multiple colors.

10) The method of manufacturing a motor vehicle license plate according to claim 1, characterized in that, in the embossing process, a embossed substructure (9) is produced that is disposed within the contour (8) of the distinguishing characters (7).

11) A motor vehicle license plate (19), consisting of a embossable carrier plate (1), a base film (3) laminated to the front face of the carrier plate (1) and of distinguishing characters (7) produced using a printing method and disposed on the front face of said base film (3), characterized in that the motor vehicle license plate (19) comprises at least one of the following micro safety characteristics:
1. a region (34) dyed in a printing process, said region being associated with a certain embossed distinguishing character (7) of the lettering of the license plate and being disposed within said character (7), with the dyed region being non-parallel oriented with regard to the plane of the carrier plate (1),
2. a embossed substructure (9) that is disposed within a embossed distinguishing character (7) of the lettering of the license plate.

12) A motor vehicle license plate (19), consisting of embossable carrier plate (1), a protective film (2) laminated to the front face of the carrier plate (1) and of distinguishing characters (7) that are disposed between the carrier plate (1) and the protective film (4) and are produced using a printing method, characterized in that the composite system (6) consisting of carrier plate (1), distinguishing characters (7) and protective film (4) is mechanically embossed according to the contour (8) of the distinguishing characters (7).

13) The motor vehicle license plate (19) according to claim 12, characterized in that a carrier film (2) is disposed between carrier plate (1) and distinguishing characters (7), said carrier film being laminated to the front face of the carrier plate (1) and that the protective film (4) is laminated to the front face of the carrier film (2).

14) The motor vehicle license plate (19) according to claim 12, characterized in that the raised regions (10) of the distinguishing characters (7) obtained in the embossing process are configured in multiple colors.

15) The motor vehicle license plate (19) according to claim 14, characterized in that the distinguishing characters comprise top surfaces (12) that are oriented to be parallel to the surface of the carrier plate (1), said top surfaces being surrounded by flanks (11), said flanks (11) being configured in another color than the top surfaces (12).

16) The motor vehicle license plate (19) according to claim 12, characterized in that the license plate (19) comprises a embossed substructure (9) disposed within the contour (8) of the distinguishing characters (7).

17) A device for producing a motor vehicle license plate (19), said device comprising the following features:
1. a printing unit (20) for carrying out the printing process,
2. a embossing unit (22) for carrying out the embossing process using embossing tools (25),
3. said embossing unit (22) comprising an automatic positioning device (24) for automatically positioning embossing tools (25) of the embossing unit (22) above printed distinguishing characters (7) that are to be embossed.

18) The device according to claim 17, characterized in that there is further provided a central control unit (23) that actuates the printing unit (20) and the embossing unit (22).

19) The device according to claim 17, characterized in that the device comprises an optical recognition device (27) for recognizing the position and/or type of the printed distinguishing characters (7) to be embossed and for transferring this information to the embossing unit (22).

20) The device according to claim 17, characterized in that the printing unit (20) is designed to transfer information regarding the position and/or type of the printed distinguishing characters (7) to be embossed to the embossing unit (22).

21) The device according to claim 17, characterized in that the embossing unit (22) comprises an automatic selection device (26) for selecting a embossing tool (25) for performing the embossing process on a printed distinguishing character (7) to be embossed, said tool being adapted to the type of the character that is to be embossed.

22) The device according to claim 17, characterized in that the embossing unit (22) is designed to receive external information regarding the position and/or type of the printed distinguishing characters (7) to be embossed and to use this information for automatically selecting and/or positioning embossing tools (25) for the embossing process.
